(19) United States
(12) Patent Application Publication
(10) Pub. No.: US 2011/0168678 A1
(43) Pub. Date: Jul. 14, 2011

(54) METHOD AND APPARATUS FOR WELDING COPPER

(75) Inventors: Hiroaki TAKEDA, Toyota-shi (JP); Keigo Moriguchi, Takahama-shi (JP); Shigeisa Nishio, Anjo-shi (JP)

(73) Assignee: DENSO CORPORATION, Kariya-city (JP)

(21) Appl. No.: 13/006,268

(22) Filed: Jan. 13, 2011

(30) Foreign Application Priority Data
Jan. 14, 2010 (JP) 2010-006256
Dec. 2, 2010 (JP) 2010-269593

(51) Int. Cl. B23K 9/16

(52) U.S. Cl. 219/74

(57) ABSTRACT

A method for welding copper includes steps of spraying an inert gas to copper that is an object to be welded to cover a portion to be welded on the copper with the inert gas, and performing electrical discharge to weld the portion to be welded. The inert gas that covers the portion to be welded passes a dehumidifying process that removes moisture contained in the inert gas.

### CROSS-REFERENCE TO RELATED APPLICATION

This application is based on and claims the benefit of priorities from earlier Japanese Patent Application Nos. 2010-006256 and 2010-269593 filed Jan. 14, 2010 and Dec. 2, 2010, respectively, the descriptions of which are incorporated herein by reference.

### TECHNICAL FIELD

The present disclosure relates to a method and apparatus for welding copper, such as ends of copper conductor segments.

### BACKGROUND

Some scheme has traditionally been used in welding copper oxide (tough pitch copper) having oxygen content of 10 ppm or more, as specified by JIS (Japanese Industrial Standards). In this scheme, an inert gas, such as argon gas, is sprayed to portions of copper oxide to be welded to cover the portions with the spray, so that the spray provides a shield for the portions against oxygen. With this shield, copper has been prevented from being oxidized by the heat accompanying welding.

As disclosed in JP-A-2001-054263, for example, this type of welding scheme is applied to the welding of ends of copper conductor segments used for the stator of a rotary electric machine.

In the above traditional scheme of welding copper, portions of copper oxide to be welded are covered with a spray of an inert gas as mentioned above to perform welding, as applied to the method disclosed in JP-A-2001-054263.

With this scheme of welding copper, however, moisture, if it is contained in the inert gas, is decomposed by the heat of the welding (welding heat) and separated into hydrogen and oxygen.

Of these two elements, hydrogen (H), If It mingles into the molten copper, is easily bound with the oxygen (O) in the copper oxide (Cu₂O) by the nature of these elements to thereby produce water (H₂O), which, in turn, is evaporated to produce moisture vapor.

If the moisture vapor is not discharged before the molten copper is solidified, the moisture vapor forms blowholes, i.e. voids.

In addition, if an organic matter, such as oil, has been attached to the portions to be welded of the copper oxide, the organic matter, which is composed of hydrogen, oxygen and carbon, is thermally decomposed to emit carbon.

The emitted carbon (C) is then bound with the oxygen (O) in the molten copper and evaporated in the form of carbon dioxide (Co₂), again leading to the formation of blowholes.

The formation of a number of blowholes in the portions to be welded of copper oxide may raise a problem of deteriorating the welding strength.

Referring to the schematic diagrams of FIGS. 9A to 9F, hereinafter is described the mechanism with which blowholes are formed in copper oxide.

First, as shown in FIG. 9A, let us assume that an arc 3 is generated between a non-consumable electrode 1 made such as of tungsten, and a molten copper pool 4. The electrode 1 has an arc-generating portion that generates the arc 3.

The arc-generating portion is shielded from air by a shield gas 2, such as argon gas, which is discharged from the electrode 1 along its perimeter. The shield gas 2 contains a small amount of moisture, while moisture in the air imperceptibly mingles into the space within the shield of the shield gas 2.

The moisture from the shield gas 2 and from the air is decomposed by the arc 3 to produce hydrogen 5 that is absorbed into the molten copper pool 4.

As shown in FIG. 9B, the hydrogen 5 forms bubbles 5a in the molten copper pool 4. Then, as shown in FIG. 9C, the molten copper at the bottom portion of the molten copper pool 4 starts solidifying as indicated by a reference numeral 6. The hydrogen 5 has a smaller solubility in solid-phase copper than in liquid-phase copper.

Accordingly, as shown in FIG. 9D, the hydrogen bubbles 5a are discharged into the liquid-phase copper through a solidification boundary 6a, drifts upward through the molten copper pool 4 and are discharged outside.

Then, as shown in FIG. 9E, the solidification 6 in the molten copper pool 4 advances. Meanwhile, the hydrogen bubbles 5a that could not keep up with the pace of discharging to the outside remain within the molten copper pool 4 to form blowholes 7 as shown in FIG. 9F.

FIG. 9F shows a state where the solidification 6 in the molten copper pool 4 has been fully achieved with the blowholes 7 being formed therein.

FIG. 10 is a diagram illustrating a relationship between mole fractions of various metallic atoms, such as aluminum (Al) and copper (Cu), and temperature (K). As indicated by a line L3 in the figure, when aluminum (or aluminum alloy) solidifies, hydrogen solubility is drastically lowered. It is known that hydrogen gas produced by such solidification forms blowholes.

On the other hand, as indicated by a line L4 in the figure, copper has low hydrogen solubility when solidified and therefore no problem is caused if blowholes are formed with the emission of hydrogen gas.

However, in the case of copper that contains oxygen (copper oxide (Cu₂O)), hydrogen (H) or carbon (C) melted into the molten copper is bound with the oxygen (O) of the copper oxide (Cu₂O) as mentioned above to produce moisture vapor (H₂O) or carbon dioxide (Co₂), which eventually forms blowholes and problematically lowers the welding strength.

### SUMMARY

An embodiment provides a method and apparatus for welding copper, which method and apparatus are able to suppress formation of blowholes in portions to be welded of copper when the copper is welded to enhance the welding strength.

In a method for welding copper according to a first aspect, the method for welding copper includes steps of spraying an inert gas to copper that is an object to be welded to cover a portion to be welded on the copper with the inert gas, and performing electrical discharge to weld the portion to be welded.

The inert gas that covers the portion to be welded passes a dehumidifying process that removes moisture contained in the inert gas.

With this method, the inert gas is dehumidified and then sprayed from gas spraying means to the portions to be welded (hereinafter also referred to as “welding portions”) of copper.

Thus, if there is residual moisture after the dehumidification, the amount of hydrogen will be reduced when the residual moisture is separated into hydrogen and oxygen by the welding heat.

Accordingly, the amount of water will also be reduced, which water is produced by the binding of the oxygen contained in the copper oxide at the welding portions with the separated hydrogen.

Therefore, when the welding heat evaporates this reduced amount of water, the number of blowholes formed will also be reduced.

As a result, blowholes are suppressed from being formed in the welding portions of the copper when the copper is welded, whereby welding strength is enhanced.

In the method for welding copper according to a second aspect, wherein, the dehumidifying process dehumidifies from the inert gas.

In the method for welding copper according to a third aspect, wherein, the method further comprises a moisture content detection process that detects the moisture content contained in the inert gas that has passed the dehumidifying process.

In the method for welding copper according to a fourth aspect, wherein, the inert gas that has passed the dehumidifying process contains 200 mg/m³ or less moisture content.

In the method for welding copper according to a fifth aspect, wherein, the inert gas that has passed the dehumidifying process contains 22.2 mg/m³ or less hydrogen content.

In the method for welding copper according to a sixth aspect, wherein, the inert gas is any one of or an optional combination of argon gas, helium gas and nitrogen gas.

In the method for welding copper according to a seventh aspect, the method further comprises a cleaning process that cleans an organic matter attached to the surface of the copper that is the object to be welded.

In the method for welding copper according to an eighth aspect, wherein, the cleaning process that cleans the organic matter attached to the surface of the copper that is the object to be welded is performed by heating the portion to be welded and achieving a heat quantity that will not allow welding of the copper.

In the method for welding copper according to a ninth aspect, wherein, welding is performed by supplying electrical power to an electrode from a power source so that hydrogen concentration falls in a specific range, the range being specified to achieve a blowhole percentage for maintaining a welding strength at a required level.

In the method for welding copper according to a tenth aspect, wherein, the copper has oxygen content of 10 ppm or more.

In an apparatus for welding copper according to a first aspect, the apparatus for welding copper includes a gas storing means filled with an inert gas, gas spraying means that sprays the inert gas taken from the gas storing means via a tube to copper that is an object to be welded to cover a portion to be welded on the copper with the inert gas, and a welding means configured by an electrode that performs electrical discharge to weld the portion to be welded and a power source that supplies electrical power such that electrical discharge occurs on the electrode.

A dehumidifier that dehumidifies the inert gas delivered from the gas storing means such that a moisture content of the inert gas is dehumidified and then delivers the dehumidified inert gas to the gas spray means is interposed in the tube disposed between the gas storing means and the gas spray means.

In the apparatus for welding copper according to a second aspect, wherein, the tube is made of a material having lower hydrophilicity than rubber and iron.

In the apparatus for welding copper according to a third aspect, wherein, when the inert gas is sprayed from the gas spraying means, the welding means supplies the electrical power being supplied from the power source to the electrode is controlled to achieve a heat quantity with which welding is not performed for the copper, and after expiration of a predetermined time period, the electrical power Is controlled to achieve a heat quantity with which the copper is welded.

In the apparatus for welding copper according to a fourth aspect, the apparatus further comprises a closing means that hermetically closes an inert gas outlet disposed at an end of the gas spraying means, an actuator that fully actuates the closing means, and a first control means that controls the actuator so that the closing means hermetically closes the inert gas outlet when the power source stops supplying electrical power to the electrode, and controls the actuator so that the closing means is retracted from an opening at the inert gas outlet when the power source supplies electrical power to the electrode for welding.

In the apparatus for welding copper according to a fifth aspect, the apparatus further comprises a sensor that senses hydrogen in the inert gas sprayed from the inert gas outlet, a measuring means that measures concentration of the hydrogen sensed by the sensor, and a second control means that controls the power source so that electrical power is supplied to the electrode when the hydrogen concentration measured by the measuring means has become equal to or less than a predetermined reference value and that electrical power is stopped when the hydrogen concentration has exceeded the reference value.

The reference value of the hydrogen concentration is predetermined such that an amount of hydrogen in the inert gas brings in a blowhole percentage for maintaining a welding strength at a required level when welding the

### BRIEF DESCRIPTION OF THE DRAWINGS

In the accompanying drawings:

FIG. 1 is a schematic diagram illustrating a configuration of a copper welding apparatus according to a first embodiment of the present disclosure;

FIG. 2 is a diagram illustrating a relationship between blowhole percentage and moisture content;

FIG. 3 is a diagram illustrating a relationship between blowhole percentage and hydrogen content;

FIG. 4 is a table numerically indicating a relationship between blowhole percentage and moisture content as well is as a relationship between blowhole percentage and hydrogen content;

FIG. 5 is a schematic diagram illustrating a configuration of a copper welding apparatus according to a second embodiment of the present disclosure;

FIG. 6 is a schematic diagram illustrating a state where an inert gas outlet of a torch has been hermetically closed by a cap, in the copper welding apparatus according to the second embodiment;

FIG. 7 is a schematic diagram illustrating a configuration of a copper welding apparatus according to a third embodiment of the present disclosure;

FIG. 8 is a diagram illustrating a relationship between moisture content and welding strength;

FIGS. 9A to 9F are explanatory diagrams illustrating a mechanism with which blowholes are formed; and

FIG. 10 is a diagram illustrating a relationship between mole fraction of various metallic atoms and temperature.

### DETAILED DESCRIPTION OF THE PREFERRED EMBODIMENTS

With reference to the accompanying drawings, hereinafter are described some embodiments of the present disclosure. Throughout the embodiments, the components identical with or similar to each other are given the same reference numerals for the sake of omitting explanation.

### First Embodiment

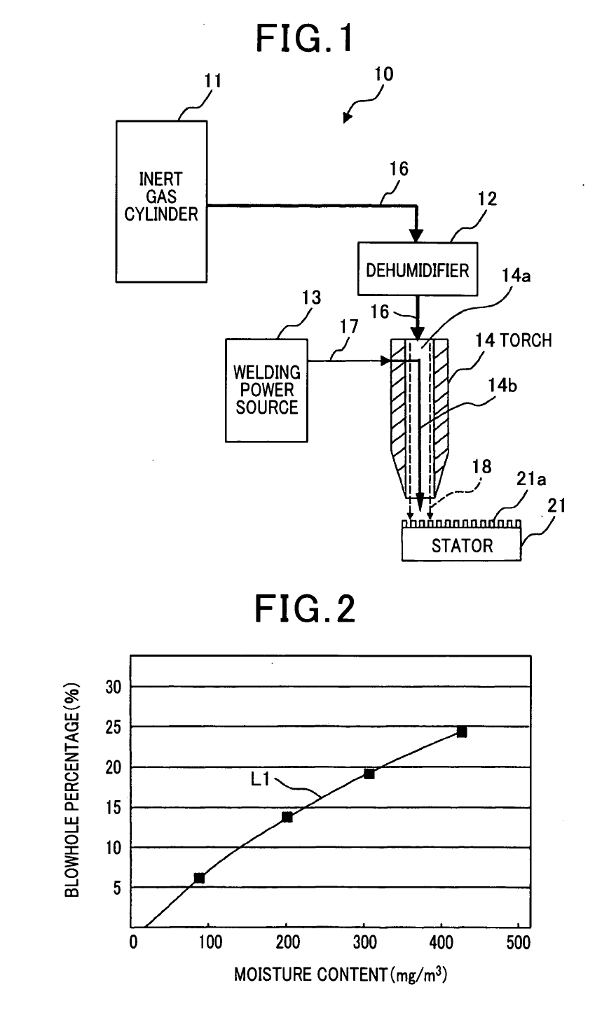

FIG. 1 is a schematic diagram illustrating a configuration of a copper welding apparatus 10 according to a first embodiment of the present disclosure. The copper welding apparatus 10 includes an inert gas cylinder (gas storing means) 11, a dehumidifier (dehumidifying means) 12, a welding power source (power source) 13 and a torch 14.

The inert gas cylinder 11 is filled with an inert gas that is any one of or an optional combination of argon gas, helium gas and nitrogen gas. The torch 14 has a long slender cylindrical shape, in which a gas spray nozzle (gas spraying means) 14a is formed. The gas nozzle 14a has a hollow portion in which a long rod electrode 14b is disposed along the longitudinal axis of the hollow portion.

It should be appreciated that, in the present embodiment, objects to be welded by the copper welding apparatus 10 are ends 21a of copper oxide conductor segments of a stator 21 used for a motor. It should also be appreciated that the welding means is configured by the welding power source 13 and the electrode 14b.

The inert gas cylinder 11 has a gas outlet that is connected to a gas inlet of the gas spray nozzle 14a of the torch 14 via a fluorinated resin tube 16 with the interposition of the dehumidifier 12 in the tube.

Meanwhile, the welding power source 13 is connected to an end of the electrode 14b of the torch 14 via a conductor cable 17. In other words, an airtight gas passage is formed from the gas outlet of the inert gas cylinder 11 to a gas outlet (opening for spraying gas) at a tip end of the gas spray nozzle 14a with the interposition of the dehumidifier 12.

The dehumidifier 12 incorporates therein a hygroscopic material, such as silica gel. The hygroscopic material absorbs a given amount of moisture contained in the inert gas delivered from the inert gas cylinder 11 via the tube 16.

The inert gas from which the given amount of moisture has been removed (hereinafter referred to as “dehumidified inert gas”) is delivered to the gas inlet of the gas spray nozzle 14a of the torch 14 via the tube 16.

As indicated by broken-line arrows 18 in FIG. 1, the dehumidified inert gas delivered in this way is passed through the gas spray nozzle 14a and sprayed from the tip end thereof to cover the ends 21a, i.e. portions to be welded (hereinafter also referred to as “welding portions”), of the conductor segments of the stator 21. This coverage with the dehumidified inert gas provides a shield for the welding portions against oxygen.

The welding power source 13 supplies electrical power to the electrode 14b of the torch 14 via the conductor cable 17. The electrical power is supplied such that electrical discharge appropriate for welding the ends 21a of the conductor segments of the stator 21 occurs between the electrode 14b and the ends 21a.

Specifically, the ends 21a, or welding portions, of the conductor segments of the stator 21 are welded with the electrical discharge from the electrode 14b, in a state where the ends 21a are covered with the dehumidified inert gas sprayed from the tip end of the gas spray nozzle 14a.

The dehumidified inert gas covering the welding portions during welding contains residual moisture. The residual moisture is separated into hydrogen and oxygen by the welding heat.

The separated hydrogen is bound with the oxygen in the copper oxide at the welding portions, thereby producing water. The welding heat evaporates the water produced in this way and the resultant moisture vapor forms blowholes.

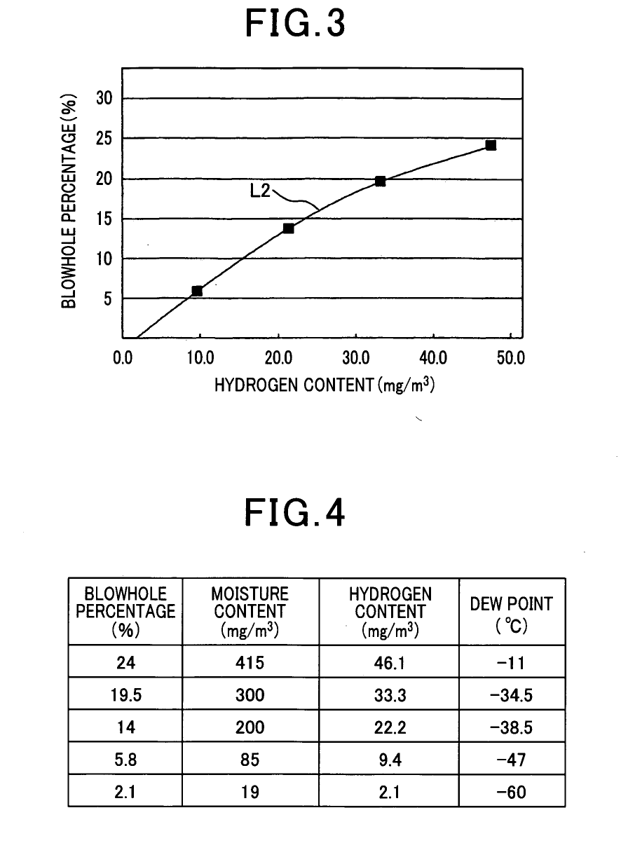

FIG. 2 is a diagram illustrating a relationship between percentage (%) of forming such blowholes (blowhole percentage) and amount of moisture (mg/m³) contained (moisture content) in the inert gas that covers welding portions. FIG. 3 is a diagram illustrating a relationship between blowhole percentage and amount of hydrogen (mg/m³) separated (hydrogen content) from moisture vapor.

A line L1 of FIG. 2 indicates blowhole percentage in terms of moisture content. A line L2 of FIG. 3 indicates blowhole percentage in terms of hydrogen content. FIG. 4 is a table numerically indicating the relationship between blowhole percentage and moisture content as well as the relationship between blowhole percentage and hydrogen content.

When a number of blowholes are formed as in traditional welding, the strength of welded portions (welding strength) of copper dioxide is weakened. Meanwhile, blowhole percentage of about 15% or less will maintain a welding strength at a level required for objects to be welded (the ends 21a of the conductor segments of the stator 21 in the present embodiment).

As shown in FIG. 4, when blowhole percentage is 14%, the moisture content is 200 mg/m³ and the hydrogen content is 22.2 mg/m³. Accordingly, in order to achieve the blowhole percentage of about 15% or less, moisture content of the inert gas covering the welding portions may have to be 200 mg/m³ or less and hydrogen content may have to be 22.2 mg/m³ or less.

Therefore, the dehumidifier 12 is permitted to dehumidify the inert gas delivered from the inert gas cylinder 11 such that the moisture content of the inert gas will be 200 mg/m³ or less or that the hydrogen content thereof will be 22.2 mg/m³ or less, and then delivers the dehumidified inert gas to the gas spray nozzle 14a of the torch 14.

As described above, the copper welding apparatus 10 to according to the present embodiment has been configured by the inert gas cylinder 11 filled with an inert gas, the torch 14 having the gas spray nozzle 14a and the electrode 14b, and the welding power source 13.

In the torch 14, the gas spray nozzle 14a sprays the inert gas, which has been taken from the inert gas cylinder 11 via the tube 16, to the ends 21a, or objects to be welded, of the copper segments of the stator 21 to cover the welding portions of the ends 21a with the inert gas.

The electrode 14b in the mean time performs electrical discharge to weld the welding portions while the welding power source 13 supplies electric power so that the electrical discharge can be carried out.

In this configuration of the present embodiment, the dehumidifier 12 is interposed in the tube 16 that is disposed between the inert gas cylinder 11 and the gas spray nozzle 14a. The dehumidifier 12 plays a role of absorbing moisture contained in the inert gas delivered from the inert gas cylinder 11 and delivering the inert gas after absorption of the moisture to the gas spray nozzle 14a.

Thus, moisture in the inert gas delivered from the inert gas cylinder 11 is absorbed by the dehumidifier 12 (i.e. the inert gas is dehumidified) and reduced. Then, the dehumidified inert gas is sprayed from the gas spray nozzle 14a to the welding portions at the ends 21a of the conductor segments of the stator 21.

Since the moisture contained in the inert gas has been reduced, the amount of hydrogen will also be reduced when the reduced amount of moisture is separated into hydrogen and oxygen by the welding heat.

Accordingly, the amount of water will also be reduced, which water is produced by the binding of the separated hydrogen with the oxygen contained in the welding portions at the ends 21a of the conductor segments of the stator 21.

As a result, the number of blowholes will also be reduced, which blowholes would be formed when the water is evaporated by the welding heat.

Thus, since the number of blowholes formed in the welding portions is reduced when the ends 21a of the conductor segments of the stator 21 are welded, the welding strength is enhanced.

Further, in the present embodiment, the inert gas delivered from the inert gas cylinder 11 is dehumidified by the dehumidifier 12 so that the amount the moisture contained in the inert gas after dehumidification will be 200 mg/m³ or less.

Accordingly, the amount of moisture is reduced to 200 mg/m³ or less in the inert gas sprayed from the gas spray nozzle 14a to the welding portions at the ends 21a of the conductor segments of the stator 21.

With this moisture content of 200 mg/m³ or less, blowhole percentage of forming blowholes in the welding portions in performing welding is reduced to 14% or less.

Since the blowhole percentage of about 15% or less maintains a welding strength at a level required for objects to be welded, as mentioned above, the blowhole percentage of 14% or less can maintain the welding strength at a required level.

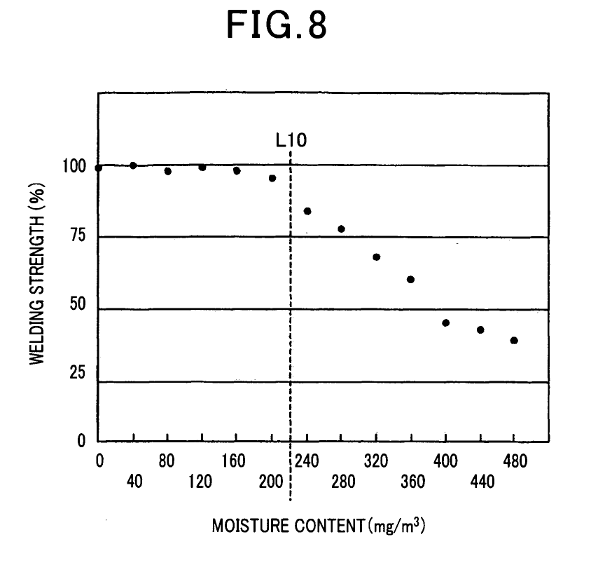

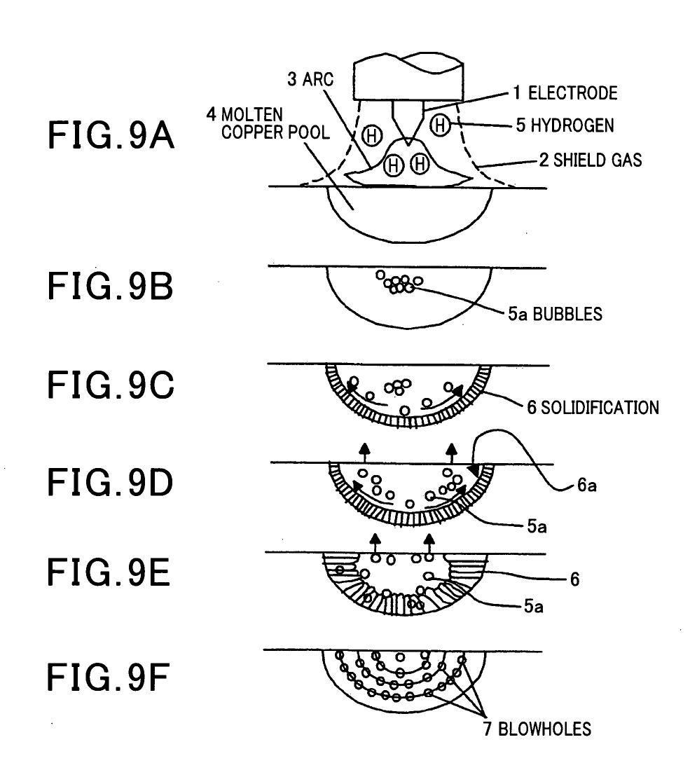

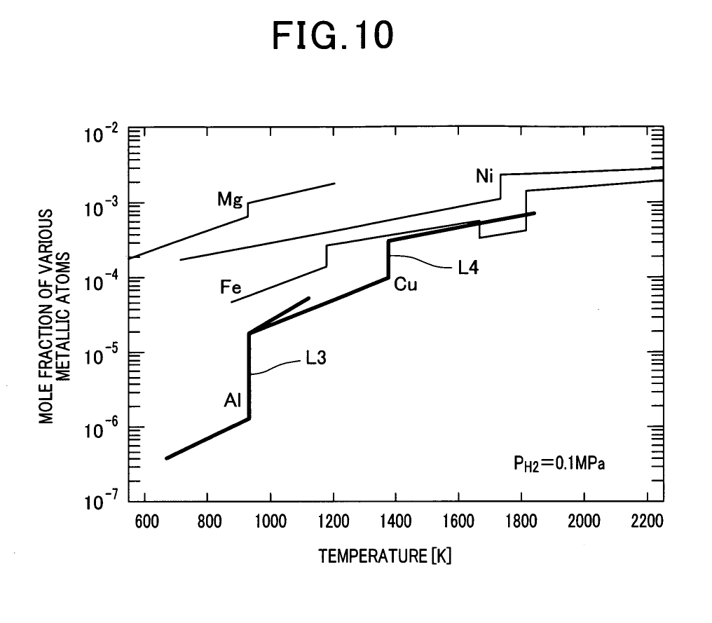

Referring now to FIG. 8, a relationship between welding strength and moisture content will be described. FIG. 8 is a diagram illustrating the relationship, with the vertical axis indicating welding strength (%) and the horizontal axis indicating moisture content (mg/m³).

It should be appreciated that, the welding strength of the vertical axis is indicated with reference to an appropriate welding strength as expressed by 100%.

As shown in FIG. 8, in welding copper having oxygen content of 10 ppm or more, welding strength is drastically reduced when moisture in the inert gas exceeds 200 mg/m³, as indicated by the vertical broken line L10.

Therefore, moisture contained in the inert gas Is ensured to be absorbed and removed by the dehumidifier 12.

Alternatively, the dehumidifier 12 may be ensured to absorb moisture contained in the inert gas delivered from the inert gas cylinder 11 such that the amount of hydrogen contained in the inert gas after absorption will be 22.2 mg/m³ or less.

Thus, hydrogen content of 22.2 mg/m³ or less is ensured in the inert gas sprayed from the gas spray nozzle 14a to the welding portions at the ends 21a of the conductor segments of the stator 21.

With this hydrogen content of 22.2 mg/m³ or less, blowhole percentage of forming blowholes in the welding portions in performing welding is ensured to be 14% or less, whereby welding strength can be maintained at a required level.

Further, the inert gas in the present embodiment is any one of or an optional combination of argon gas, helium gas and nitrogen gas.

Specifically, no one of argon gas, helium gas and nitrogen gas is a gas that binds with an element in the ends 21a, or objects to be welded, made of copper and causes blowholes in performing welding. Therefore, the inert gas per se will not be the cause of blowholes.

In the present embodiment, the tube 16 made of fluorinated resin is used to connect between the inert gas cylinder 11 and the gas spray nozzle 14a with the interposition of the dehumidifier 12.

Instead of fluorinated resin, the tube 16 may be made of a different material having lower hydrophilicity than stainless steel-based or copper-based rubber and iron.

Use of such a material ensures will not allow attachment of moisture to the inner wall surface of the tube 16. Accordingly, moisture that would cause blowholes will not be mingled into the inert gas passing through the tube 16.

Welding performed by the torch 14 for the ends 21a of the conductor segments of the stator 21 may be any one of arc welding, laser welding and electronic welding (electronic beam welding).

The arc welding makes use of electrical discharge phenomenon (arc discharge) to join the same metallic materials to each other.

The laser welding makes use of a laser element on which light is thrown to induce stimulated emission phenomenon (optical excitation) that causes emission of light for welding.

The electronic welding (electronic beam welding) makes use of an electronic beam of extremely high power density that has been accelerated, converged and controlled with the application of high voltage within vacuum to perform melting and welding.

Use of any one of these welding processes can reduce the number of blowholes.

When the inert gas is sprayed from the gas spraying means, the electrical power supplied from the welding power source 13 to the electrode 14b may be controlled.

Specifically, in an initial period of supplying the electrical power, the electrical power may be controlled to achieve a heat quantity with which welding is not performed for the ends 21a of the copper conductor segments of the stator 21, or objects to be welded.

Then, after expiration of a predetermined time period, the electrical power may be controlled to achieve a heat quantity with which the copper is welded.

Thus, electrical power is supplied to the electrode 14b such that a heat quantity that will not allow welding of the copper, or objects to be welded, is achieved in an initial period of supplying the electrical power.

Therefore, an organic matter, such as oil, if it has been attached to the welding portions, is decomposed by the heat and removed.

The organic matter to be removed consists of hydrogen, oxygen and carbon. Therefore, if welding is performed with the organic matter being attached to the welding portions, the organic matter would be thermally decomposed into hydrogen, oxygen and carbon, thereby emitting carbon.

The emitted carbon would then be bound with the oxygen in the molten copper and evaporated in the form of carbon dioxide, causing blowholes.

In the present embodiment, however, the organic matter is removed, as mentioned above, from the welding portions.

Accordingly, when welding is performed after expiration of the predetermined time period with the subsequent supply of electrical power, blowholes will not be substantially formed, which blowholes would have otherwise been formed with the emission of the carbon dioxide.

Prior to performing welding, a cleaning process may be performed to clean an organic matter that contains coating debris and oil components and has been attached to the surface of the copper, or objects to be welded.

Thus, if an organic matter, such as oil, has been attached to the welding portions, the organic matter is decomposed by the heat and removed, whereby blowholes will not be substantially formed.

In the cleaning process mentioned above, coating debris, oil components and the like attached to the surface of the copper, or objects to be welded, may be cleaned by heating the welding portions and achieving a heat quantity that will not allow welding of the copper.

Thus, since the heat quantity supplied to the welding portions is of a level that will not allow welding of the welding portions of the copper, an organic matter, such as oil, if it has been attached to the welding portions, will be decomposed by the heat and removed.

Thus, blowholes will not be substantially formed.

Welding may be performed by supplying electrical power to the electrode 14b from the power source so that the hydrogen concentration falls in a specific range, the range being specified to achieve a blowhole percentage for maintaining a welding strength at a required level.

In this way, electrical power is supplied to the electrode 14b such that the hydrogen concentration falls within a range with which a blowhole percentage is achieved for maintaining a welding strength at a required level. Thus, unwanted blowholes will no longer be formed.

The ends 21a, or objects to be welded, of copper may have oxygen content of 10 ppm or more. In copper having oxygen content of 10 ppm or more, i.e. tough pitch copper, the oxygen in particular (O) of copper oxide (Cu₂O) is easily bound with hydrogen (H) by the nature of these elements to produce water (H₂O).

Thus, in such copper, blowholes are easily formed with the evaporation of the water.

However, according to the present embodiment, formation of blowholes will be substantially prevented even in such tough pitch copper, as described above.

### Second Embodiment

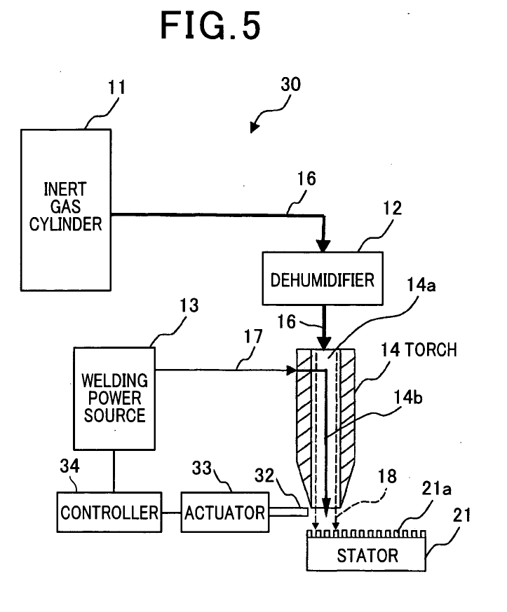

Referring to FIG. 5, hereinafter is described a second embodiment of the present disclosure. FIG. 5 is a schematic diagram illustrating a configuration of a copper welding apparatus 30 according to the second embodiment.

The copper welding apparatus 30 according to the second embodiment is different from the copper welding apparatus 10 according to the first embodiment in that the former includes a cap (closing means) 32, an actuator 33 that fully actuates the cap 32, and a controller (first control means) 34, in addition to the components of the latter.

While the welding power source 13 supplies electrical power for welding (also referred to as “welding power”) to the electrode 14b, the controller 34 controls the actuator 33 so that the cap 32 is retracted from the opening at a tip end (i.e. inert gas outlet) of the gas spray nozzle 14a of the torch 14.

Then, when the welding power source 13 stops supply of welding power, the controller 34 controls the actuator 33 so that the cap 32 hermetically closes the inert gas outlet of the torch 14.

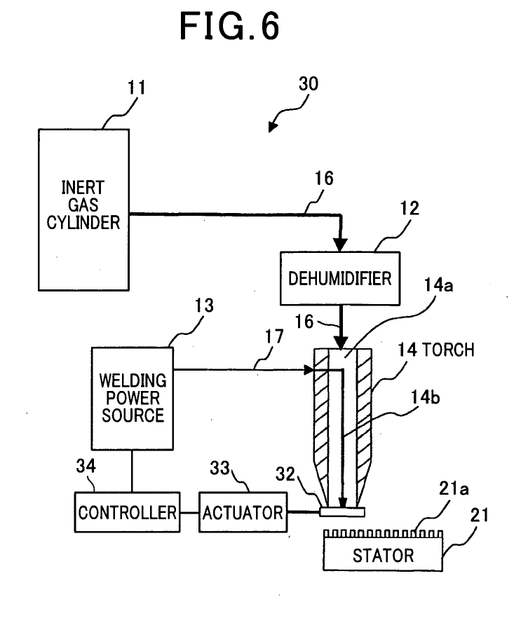

FIG. 6 is a schematic diagram illustrating the state where the inert gas outlet of the torch 14 has been hermetically closed with the cap 34 in the copper welding apparatus 30.

Then, when the supply of welding power is resumed, the controller 34 controls the actuator 33 so that the cap 32 is retracted from the inert gas outlet of the torch 14.

Under such control, the inert gas outlet of the torch 14 is hermetically dosed when welding with the torch 14 is stopped. Accordingly, an inert gas passage formed by the gas spray nozzle 14a and the tube 16 extending from the gas spray nozzle 14a to the inert gas cylinder 11 with the interposition of the dehumidifier 12 is shut off from the outside air.

In this way, the outside air containing moisture that would cause blowholes is prevented from entering the inert gas passage. As a result, formation of blowholes will be suppressed when the inert gas outlet at a tip end of the inert gas passage is opened again and the inert gas is sprayed for the resumption of welding.

### Third Embodiment

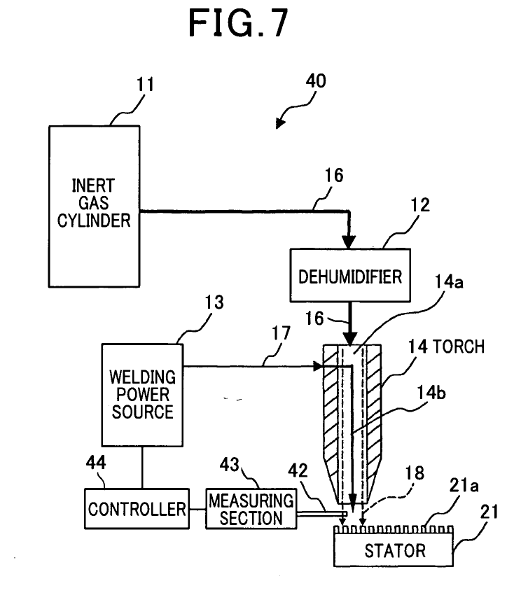

Referring to FIG. 7, a third embodiment of the present disclosure is described.

FIG. 7 is a schematic diagram illustrating a configuration of a copper welding apparatus 40 according to a third embodiment of the present disclosure.

The copper welding apparatus 40 according to the third embodiment is different from the copper welding apparatus 10 according to the first embodiment in that the former includes a sensor 42, a measuring section (measuring means) 43 and a controller (second control means) 44, in addition to the components of the latter.

The sensor 42 senses hydrogen in the inert gas sprayed from the gas spray nozzle 14a. The measuring section 43 measures concentration of the hydrogen sensed by the sensor 42.

The controller 44 controls the welding power source 13 so that welding power is supplied to the electrode 14b when the hydrogen concentration measured by the measuring section 43 has become equal to or less than a predetermined reference value and that welding power is stopped when the hydrogen concentration has exceeded the reference value.

The reference value of the hydrogen concentration, however, is predetermined such that the amount of hydrogen in the inert gas sprayed from the gas spray nozzle 14a brings in a blowhole percentage for maintaining a welding strength at a required level, in welding the ends 21a, or objects to be welded, of the conductor segments of the stator 21.

The blowhole percentage for maintaining a welding strength at a required level is about 15% or less. Accordingly, for example, a reference value of hydrogen concentration may be set to a value corresponding to a hydrogen content of 22.2 mg/m³ or less which will bring in a blowhole percentage of 14% or less.

According to the copper welding apparatus 40 of the third embodiment, the objects to be welded are subjected to welding only when the hydrogen concentration is equal to or less than a reference value.

Accordingly, blowhole percentage of the welding portions is rendered to be about 15% or less for maintaining a welding strength at a required level.

The measuring section 43 having the sensor 42 as well as the controller 44 may be applied to the copper welding apparatus 30 according to the second embodiment shown in FIG. 5.

What is claimed is:

1. A method for welding copper comprising:
spraying an inert gas to copper that is an object to be welded to cover a portion to be welded on the copper with the inert gas; and
performing electrical discharge to weld the portion to be welded, wherein,
the inert gas that covers the portion to be welded passes a dehumidifying process that removes moisture contained in the inert gas.

2. The method for welding copper according to claim 1, wherein,
the dehumidifying process dehumidifies from the inert gas.

3. The method for welding copper according to claim 1, wherein,
the method further comprises a moisture content detection process that detects the moisture content contained in the inert gas that has passed the dehumidifying process.

4. The method for welding copper according to claim 1, wherein,
the inert gas that has passed the dehumidifying process contains 200 mg/m³ or less moisture content.

5. The method for welding copper according to claim 1, wherein,
the inert gas that has passed the dehumidifying process contains 22.2 mg/m³ or less hydrogen content.

6. The method for welding copper according to claim 1, wherein,
the inert gas is any one of or an optional combination of argon gas, helium gas and nitrogen gas.

7. The method for welding copper according to claim 1,
the method further comprises a cleaning process that cleans an organic matter attached to the surface of the copper that is the object to be welded.

8. The method for welding copper according to claim 7, wherein,
the cleaning process that cleans the organic matter attached to the surface of the copper that is the object to be welded is performed by heating the portion to be welded and achieving a heat quantity that will not allow welding of the copper.

9. The method for welding copper according to claim 1, wherein,
welding is performed by supplying electrical power to an electrode from a power source so that hydrogen concentration falls in a specific range, the range being specified to achieve a blowhole percentage for maintaining a welding strength at a required level.

10. The method for welding copper according to claim 1, wherein,
the copper has oxygen content of 10 ppm or more.

11. An apparatus for welding copper comprising:
a gas storing means filled with an inert gas,
gas spraying means that sprays the inert gas taken from the gas storing means via a tube to copper that is an object to be welded to cover a portion to be welded on the copper with the inert gas, and
a welding means configured by an electrode that performs electrical discharge to weld the portion to be welded and a power source that supplies electrical power such that electrical discharge occurs on the electrode, wherein,
a dehumidifier that dehumidifies the inert gas delivered from the gas storing means such that a moisture content of the inert gas is dehumidified and then delivers the dehumidified Inert gas to the gas spray means is interposed in the tube disposed between the gas storing means and the gas spray means.

12. The apparatus for welding copper according to claim 11, wherein,
the tube is made of a material having lower hydrophilicity than rubber and iron.

13. The apparatus for welding copper according to claim 11, wherein,
when the inert gas is sprayed from the gas spraying means, the welding means supplies the electrical power being supplied from the power source to the electrode is controlled to achieve a heat quantity with which welding is not performed for the copper, and
after expiration of a predetermined time period, the electrical power Is controlled to achieve a heat quantity with which the copper is welded.

14. The apparatus for welding copper according to claim 11,
the apparatus further comprises:
a closing means that hermetically closes an inert gas outlet disposed at an end of the gas spraying means,
an actuator that fully actuates the closing means, and
a first control means that controls the actuator so that the closing means hermetically closes the inert gas outlet when the power source stops supplying electrical power to the electrode, and controls the actuator so that the closing means is retracted from an opening at the inert gas outlet when the power source supplies electrical power to the electrode for welding.

15. The apparatus for welding copper according to claim 11,
the apparatus further comprises:
a sensor that senses hydrogen in the inert gas sprayed from the inert gas outlet,
a measuring means that measures concentration of the hydrogen sensed by the sensor, and
a second control means that controls the power source so that electrical power is supplied to the electrode when the hydrogen concentration measured by the measuring means has become equal to or less than a predetermined reference value and that electrical power is stopped when the hydrogen concentration has exceeded the reference value, wherein,
the reference value of the hydrogen concentration is predetermined such that an amount of hydrogen in the inert gas brings in a blowhole percentage for maintaining a welding strength at a required level when welding the copper.
